(19) United States
(12) Patent Application Publication
(10) Pub. No.: US 2011/0271041 A1
(43) Pub. Date: Nov. 3, 2011

(54) ELECTRONIC DEVICE COMPRISING FLASH MEMORY AND RELATED METHOD OF HANDLING PROGRAM FAILURES

(75) Inventors: Mi-Hyang LEE, Hwaseong-si (KR); Jun-Ho JANG, Seoul (KR); Seung-Jin JUNG, Yongin-si (KR)

(73) Assignee: SAMSUNG ELECTRONICS CO., LTD., Suwon-si (KR)

(21) Appl. No.: 13/074,224

(22) Filed: Mar. 29, 2011

(30) Foreign Application Priority Data
May 3, 2010 (KR) 10-2010-0041401

(51) Int. Cl. G06F 12/02

(52) U.S. Cl. 711/103; 711/E12.008

(57) ABSTRACT

A storage device performs a program operation to store program data in a selected memory block of a flash memory. The storage device allocates a reserved area of the flash memory as a free block upon detecting that a program failure has occurred in the program operation, reads the program data from a cache latch in a page buffer of the flash memory, copies valid data stored in the selected memory block to a first area of the free block, and reprograms the program data read from the cache latch to a second area of the free block.

### CROSS-REFERENCE TO RELATED APPLICATIONS

This application claims priority under 35 U.S.C. §119 to Korean Patent Application No. 10-2010-0041401 filed on May 3, 2010, the disclosure of which is hereby incorporated by reference in its entirety.

### BACKGROUND OF THE INVENTION

Embodiments of the inventive concept relate generally to electronic memory technologies. More particularly, embodiments of the inventive concept relate to electronic devices comprising flash memory and methods of handling program failures in the electronic devices.

Semiconductor memory devices can be roughly divided into two categories according to whether they retain stored data when disconnected from power. These categories include volatile memory devices, which lose stored data when disconnected from power, and nonvolatile memory devices, which retain stored data when disconnected from power. Examples of volatile memory devices include dynamic random access memory (DRAM) and static random access memory (SRAM). Examples of nonvolatile memory devices include masked read-only memory (MROM), programmable read-only memory (PROM), erasable programmable read-only memory (EPROM), electrically erasable programmable read-only memory (EEPROM), and flash memory.

Flash memory is commonly used to store audio and video data in host devices such as computers, portable phones, personal digital assistants (PDAs), digital cameras, voice recorders, MP3 players, personal portable terminals, handheld personal computers, game machines, fax machines, scanners, and printers.

Flash memory can be integrated in various types of devices, such as multimedia cards (MMCs), secure digital (SD) cards, smartmedia (SM) cards, and compact flash cards. Moreover, flash memory can be used as a main storage component in a mass storage device such as universal serial bus (USB) memory or a solid-state drive (SSD).

A storage device comprising a flash memory can be used in conjunction with various other electronic devices. Accordingly, the flash memory may be required to store various types of data according to the different functions of the electronic devices. In many such devices, the flash memory is required to store and retrieve data with a low error rate. As a result, the flash memory should be designed to address potential sources of error.

### SUMMARY OF THE INVENTION

According to one embodiment of the inventive concept, a method is provided for operating a storage device comprising a flash memory. The method comprises performing a program operation to store program data in a selected memory block of the flash memory, allocating a reserved area of the flash memory as a free block upon detecting that a program failure has occurred in the program operation, reading the program data from a cache latch in a page buffer of the flash memory, copying valid data stored in the selected memory block to a first area of the free block, and reprogramming the program data read from the cache latch to a second area of the free block.

According to another embodiment of the inventive concept, a method is provided for operating a storage device comprising a flash memory. The method comprises inhibiting a cache latch in a page buffer of the flash memory from resetting, loading program data stored in the cache latch to a program latch of the page buffer, performing a program operation to store the program data loaded in the program latch to a memory block of the flash memory, allocating a reserved area of the flash memory as a free block as a consequence of a program failure in the program operation, reading and buffering the program data from the cache latch, copying valid data stored in a program failed memory block to a first area of the free block, and reprogramming the buffered program data to a second area of the free block.

According to still another embodiment of the inventive concept, an electronic device comprises a flash memory comprising a page buffer that retains program data in a cache latch during a program operation comprising a plurality of program loops, and a host that controls the program operation and, in response to a program failure in the program operation, allocates a free memory block in the flash memory and controls a reprogram operation that programs the program data retained in the cache latch to the free block.

These and other embodiment of the inventive concept can potentially improve the accuracy of program operations by addressing programming failures, and they can potentially be used to handle program failures using a relatively low capacity buffer.

### BRIEF DESCRIPTION OF THE DRAWINGS

The drawings illustrate selected embodiments of the inventive concept. In the drawings, like reference numbers indicate like features.

FIG. 1 is a diagram illustrating an electronic device comprising a storage device according to an embodiment of the inventive concept.

FIG. 2 is a diagram illustrating a storage controller in the storage device of FIG. 1 according to an embodiment of the inventive concept.

FIG. 3 is a diagram illustrating an electronic device comprising a storage device according to another embodiment of the inventive concept.

FIG. 4 is a diagram illustrating a flash memory in the storage device of FIG. 1 or 3.

FIG. 5 is a diagram illustrating data values of a page buffer of FIG. 4 during a program operation of a flash memory device.

FIG. 6 is a diagram illustrating software layered architecture of the electronic device of FIG. 1 or 3.

FIG. 7 is a diagram for explaining an address mapping operation performed by the software layered architecture of FIG. 6.

FIGS. 8 and 9 are diagrams for explaining a bad block processing method performed upon detection of a program failure.

FIG. 10 is a flowchart illustrating a method of performing program failure processing in a program operation according to an embodiment of the inventive concept.

FIG. 11 is a flowchart illustrating a method of performing program failure processing in a program operation according to another embodiment of the inventive concept.

FIG. 12 is a flowchart illustrating method of performing program failure processing in a program operation according to still another method of the inventive concept.

FIG. 13 is a flowchart illustrating a method of performing program failure processing in a program operation according to still another embodiment of the inventive concept.

FIG. 14 is a diagram illustrating an electronic device according to another embodiment of the inventive concept.

FIG. 15 is a diagram illustrating an electronic device according to still another embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

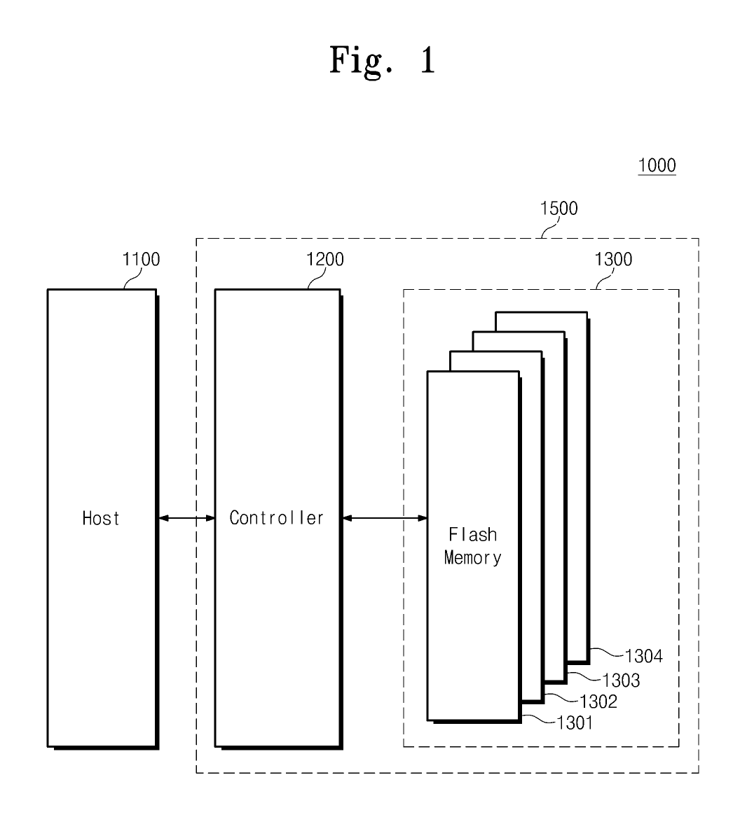

FIG. 1 is a diagram illustrating an electronic device 1000 comprising a storage device 1500 according to an embodiment of the inventive concept.

Referring to FIG. 1, electronic device 1000 comprises a host 1100 and storage device 1500. Host 1100 is configured to control storage device 1500.

Host 1100 can take any of several forms including, for example, a portable electronic device such as a personal/portable computer, a personal digital assistant (PDA), a portable multimedia player (PMP), or an MP3 player.

Host 1100 and storage device 1500 can be connected to each other through any of several interface types such as a USB interface, a small computer system interface (SCSI), an enhanced small disk interface (ESDI), a serial-advanced technology attachment (SATA) interface, a serial attached SCSI (SAS) interface, a peripheral component interconnection (PCI) express interface, an integrated drive electronics (IDE) interface, and others.

Storage device 1500 can take a variety of forms, such as a solid-state disk or a solid-state drive (SSD). In certain embodiments described below, storage device 1500 comprises an SSD. However, this is merely an example, and storage device 1500 can take other forms. Moreover, in certain embodiments, storage device 1500 is integrated in a single semiconductor device and configured as a memory card, such as a personal computer memory card international association (PCMCIA) card, a compact flash (CF) card, a smart media (SM) card, a memory stick, a multimedia card, a secure digital card, or a universal flash storage (UFS) card.

Storage device 1500 comprises a storage controller 1200 and a main storage 1300. Storage controller 1200 controls read, program, and erase operations of main storage 1300 in response to requests from host 1100.

Main storage 1300 comprises a plurality of nonvolatile memories. The plurality of nonvolatile memories can be connected in common to a plurality of channels. FIG. 1 illustrates a single channel commonly connected to each of a plurality of flash memories 1301 through 1304. However, the channel structure can be modified in a variety of ways, as indicated by various examples described below. Flash memories 1301 through 1304 perform read, program, and erase operations through the channel in response to requests from host 1100.

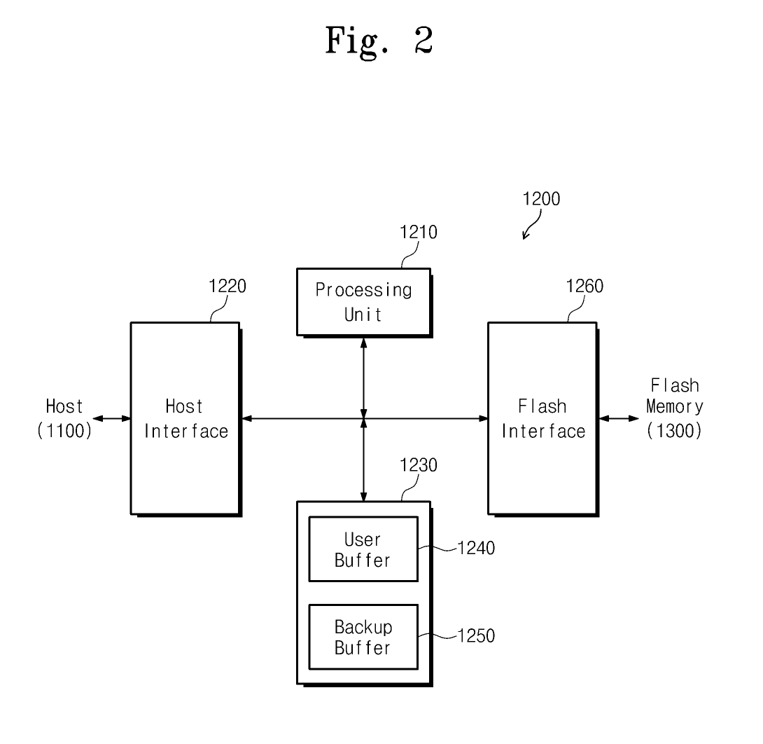

FIG. 2 is a diagram illustrating an embodiment of storage controller 1200 of FIG. 1.

Referring to FIG. 2, storage controller 1200 comprises a host interface 1220, a flash interface 1260, a processing unit 1210, and a buffer memory 1230. The structure of storage controller 1200 is not limited to that illustrated in FIG. 2, and can vary in other embodiments. For example, in some embodiments, storage controller 1200 further comprises an error correction code (ECC) circuit that detects and corrects errors in data stored in main storage 1300.

Host interface 1220 provides an interface with host 1100. Flash interface 1260 provides an interface with main storage 1300. Processing unit 1210 controls overall operations of storage controller 1200. In some embodiments, processing unit 1210 comprises a commercially available or custom microprocessor.

Buffer memory 1230 typically comprises at least one general-purpose memory for storing software and data for operating storage device 1500. For instance, in some embodiments, buffer memory 1230 comprises an SRAM or a DRAM. Buffer memory 1230 is divided into a user buffer 1240 and a backup buffer 1250. User buffer 1240 is used for temporarily storing data to be stored in main storage 1300 or read from main storage 1300. Backup buffer 1250 is used for backing up data, such as program data, provided from user buffer 1240 to main storage 1300.

In a program operation for programming first through M-th pages (M≧1) of program data into main storage 1300, backup buffer 1250 stores the first page of program data provided from user buffer 1240 until a program pass/fail verification for the first page of program data is completed. In a similar manner, backup buffer 1250 stores each of the second through (M-1)-th pages of program data provided successively from user buffer 1240, until each of the program pass/fail verifications for the second through (M-1)-th pages of program data are completed.

Upon providing the M-th page of program data (i.e., the last page of program data), storage controller 1200 resets user buffer 1240 and backup buffer 1250 and notifies host 1100 that a program operation has been completed. Consequently, backup buffer 1250 does not retain the Mth page of program data until a program pass/fail verification for the Mth page of program data is completed because user buffer 1240 and backup buffer 1250 are reset.

To address this issue, storage device 1500 performs a backup operation for the program data, especially for the Mth page of program data, by using a cache latch CL included in a page buffer of the flash memory configured in main storage 1300. In addition, where a program failure is detected, a reprogram operation for the program data to be programmed in a program failed memory cell is performed using the program data stored in cache latch CL.

Where host 1100 requests a program operation, processing unit 1210 controls flash interface 1260 and buffer memory 1230 to perform the program operation in at least one of flash memories 1301 through 1304. Flash interface 1260 provides an interface between buffer memory 1230 and flash memories 1301 through 1304 under the control of processing unit 1210.

Processing unit 1210 controls cache latch CL to retain the program data without reset during the program operation of flash memories 1301 through 1304. Where a program failure is detected, processing unit 1210 controls at least one of flash memories 1301 through 1304 to perform the reprogram operation using the program data retained in cache latch CL. As a result, valid data stored in a program failed memory block can be copied to a corresponding area of a newly allocated memory block of the flash memory. The copy operation for the valid data can be performed through a copyback operation of the flash memory.

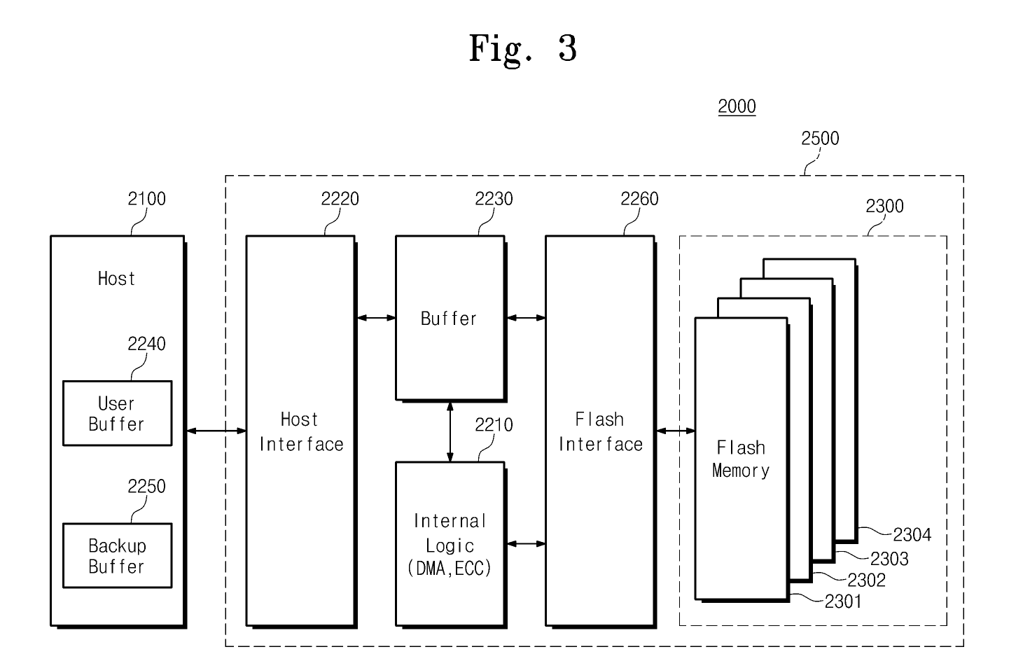

FIG. 3 is a diagram illustrating an electronic device 2000 comprising a storage device 2500 according to another embodiment of the inventive concept.

Referring to FIG. 3, electronic device 2000 comprises a host 2100 and a storage device 2500. Storage device 2500 comprises a main storage 2300, an internal logic 2210, a host interface 2220, an internal buffer 2230, and a flash interface 2260. Main storage 2300 is typically formed of a plurality of nonvolatile memory chips, such as a plurality of flash memories 2301 through 2304.

In some embodiments, storage device 2500 is integrated in a single semiconductor device. For example, storage device 2500 can be implemented by a One-NAND flash memory comprising an integrated controller or a Managed-NAND flash memory. In some embodiments, an error correction circuit ECC is included in the One-NAND flash memory or the Managed-NAND flash memory. However, storage device 2500 can take forms other than those described.

Host 2100 controls storage device 2500. Host 2100 comprises a user buffer 2240 and a backup buffer 2250. User buffer 2240 temporarily stores user data to be stored in main storage 2300 or read from main storage 2300. Backup buffer 2250 backs up program data provided from user buffer 2240 to main storage 2300 for a program operation. User buffer 2240 and backup buffer 2250 typically each comprise an SRAM or a DRAM.

Host interface 2220 provides an interface between host 2100 and storage device 2500. For instance, host interface 2220 can provide a NOR-flash interface or a NAND-flash interface.

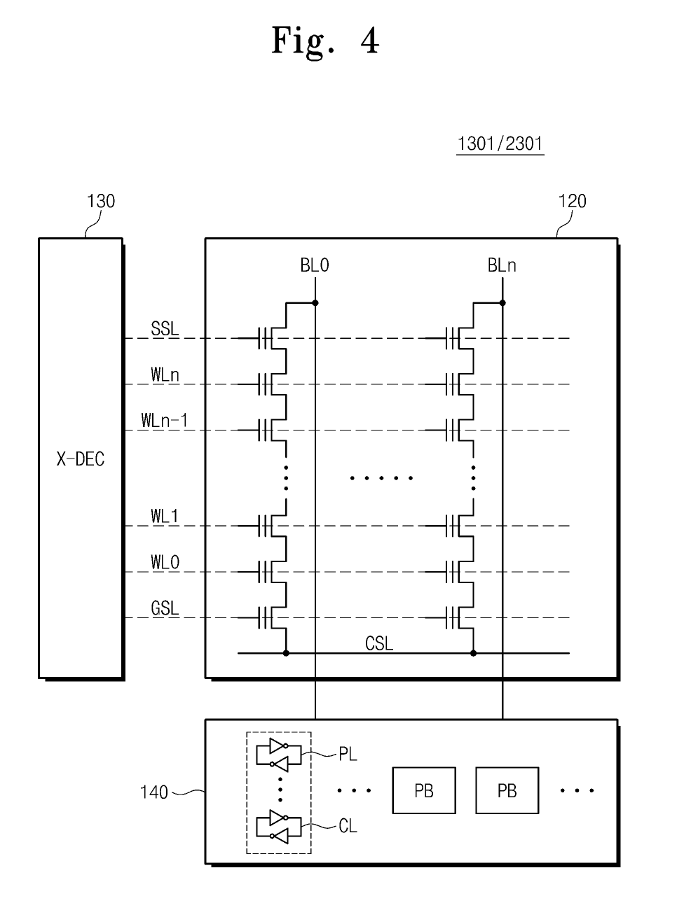

FIG. 4 is a diagram illustrating an example of flash memory 1301 or 2301 shown in FIG. 1 or 3. The flash memory of FIG. 4 is a representative example of the plurality of flash memories that can be included in main storage 1300 or 2300.

Referring to FIG. 4, flash memory 1301 or 2301 comprises a memory cell array 120, a row decoder 130, and a page buffer circuit 140. Memory cell array 120 comprises a plurality of memory cells arranged at intersections of word lines and bit lines.

Row decoder 130 drives rows of memory cell array 120, and page buffer circuit 140 drives columns of memory cell array 120. Page buffer circuit 140 is controlled by internal logic 2210 and operates as a write driver or a sense amplifier according to an operation mode of flash memory 1301 or 2301. For example, page buffer circuit 140 can operate as a sense amplifier in a mode corresponding to a read operation and can operate as a write driver in a mode corresponding to a program operation.

Page buffer circuit 140 comprises a plurality of page buffers PB. Each of the plurality of page buffers PB corresponds to a bit line or a pair of bit lines. A plurality of latches is included in each of page buffers PB. One latch in each of page buffers PB is used as a cache latch CL to temporarily store program data. Another latch in each of the page buffers PB is used as a program latch PL to store program data provided from cache latch CL in a program operation. The structure of page buffer PB is not limited to that shown in FIG. 4, and can vary in other embodiments.

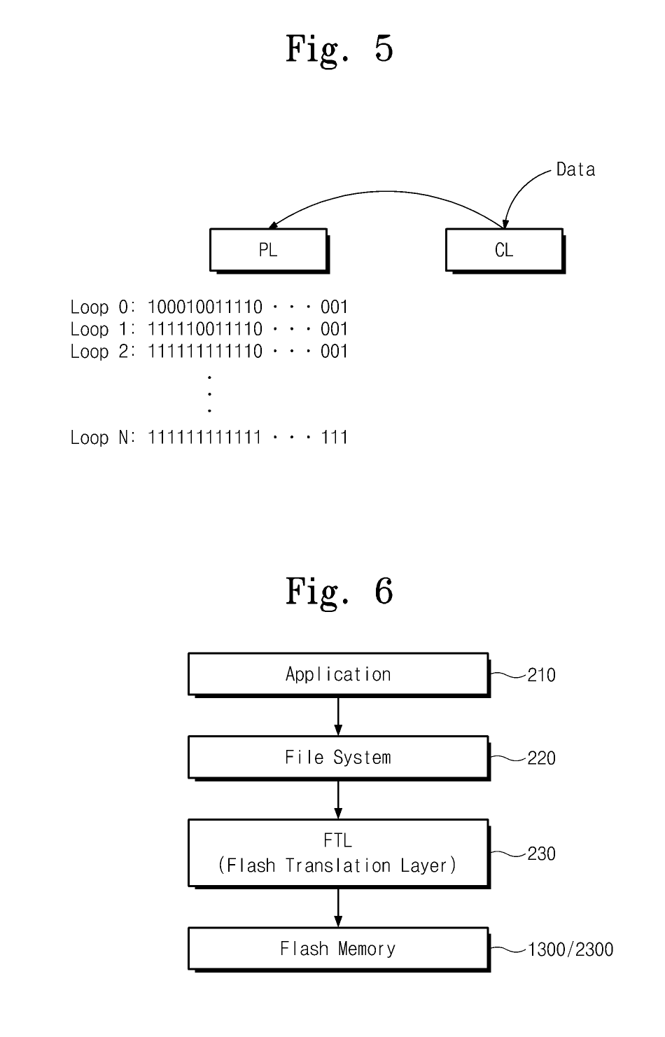

FIG. 5 is a diagram illustrating data values of page buffer PB of FIG. 4 during a program operation of flash memory 1301 or 2301. For explanation purposes, it will be assumed that the program operation is performed in a unit of a page.

Referring to FIGS. 4 and 5, at the beginning of the program operation, each bit of a page of program data is loaded into one of cache latches CL in page buffer circuit 140. Then, to perform the program operation, each bit of the program data in cache latches CL is transferred to a corresponding one of program latches PL of page buffer circuit 140. During the program operation, storage controller 1200 or host 1100 or 2100 inhibits cache latches CL from resetting. Accordingly, page buffer circuit 140 retains at least one page of program data through cache latches CL after transferring the program data. Cache latches CL of page buffer circuit 140 retain the program data until the program operation is completed. Where storage controller 1200 or host 1100 or 2100 does not inhibit cache latches CL from resetting, cache latches CL may be reset and lose the program data as soon as the program data in cache latches CL is transferred to program latches PL.

The program data stored in program latches PL is programmed to corresponding memory cells through a plurality of program loops (e.g., N program loops, where N 2). In each program loop, the program data is programmed to selected memory cells, and a pass/fail check is performed to determine whether the selected memory cells have been successfully programmed. The pass/fail check determines whether respective threshold voltages of the selected memory cells have reached desired levels. The pass/fail check is performed concurrently on the selected memory cells.

Based on the pass/fail check, the selected memory cells are classified as cells requiring further programming and memory cells not requiring further programming. Selected memory cells that do not require further programming are those that have reached a desired threshold voltage. Program latches PL corresponding to selected memory cells not requiring further programming are set into “1”, which represents a passed state. The passed state indicates that the program operation for a corresponding memory cell has been completed as of the current program loop. Selected memory cells that require further programming are those that have not reached the desired threshold voltage. These memory cells are deemed to have a failed state, which means that they have not been successfully programmed as of the current program loop. The pass/fail check result for each of the program loops is used in a program pass/fail verification to detect selected memory cells in the failed state (referred to as “failed cells”) and to detect memory blocks having failed cells.

As indicated above, the number of program loops in a program operation can be set to a predetermined number N. Where the program operation does not successfully program each of the selected memory cells after N program loops, a memory block containing the selected memory cells is identified as a program failed memory block. Valid data stored in the program failed memory block is copied to a corresponding area of an empty memory block. Then, data to be programmed in the selected memory cells is reprogrammed in memory cells of the empty memory block. The reprogram operation is performed using the program data retained in cache latches CL of page buffer circuit 140.

The reprogram operation can be performed even if all of the program data is not stored in backup buffer 1250 or 2250 or a capacity of backup buffer 1250 or 2250 is too small to store all of the program data. Therefore, program accuracy can be improved and a program failure can be processed efficiently using a relatively low capacity backup buffer 1250 or 2250.

Referring again to FIG. 3, internal buffer 2230 is controlled by internal logic 2210 and temporally stores data provided from host 2100 or page buffer circuit 140. In various alternative embodiments, internal buffer 2230 can be located either inside or outside of flash memories 2301 through 2304. Internal buffer 2230 typically comprises an SRAM. However, internal buffer 2230 can take other forms such as a DRAM and others.

Internal logic 2210 controls overall operations of storage device 2500. For example, where host 2100 requests a program operation, internal logic 2210 controls flash interface 2260 and internal buffer 2230 to perform the program operation in a selected flash memory, such as flash memory 2301. Flash interface 2260 acts as an interface between internal buffer 2230 and page buffer circuit 140 under the control of internal logic 2210. In a program operation of flash memory 2301, internal logic 2210 inhibits cache latches CL included in page buffer circuit 140 from resetting. As a result, program data stored in cache latches CL is retained until program pass/fail verification is completed. In addition, internal logic 2210 controls a reprogram operation to reprogram retained program data in cache latches CL into a newly allocated memory block of flash memory 2301 after a program failure occurs.

Both the operation for controlling cache latches CL and the operation for controlling the reprogram operation can be performed in response to a control signal or a command from host 1100 or 2100, or storage controller 1200.

Valid data in a program failed memory block is copied into a corresponding area of a newly allocated memory block under the control of internal logic 2210. The copy operation for the valid data is performed by a copyback operation of the flash memory.

Where main storage 1300 or 2300 comprises a plurality of nonvolatile memories (e.g., flash memories), storage device 1500 or 2500 can retain stored data even when disconnected from power. Each of flash memories forming main storage 1300 or 2300 comprises a plurality of memory cells arranged in a string structure. The aggregation of these memory cells is called a memory cell array. A memory cell array of main storage 1300 or 2300 is configured with a plurality of memory blocks. Each of the memory blocks comprises a plurality of pages. Each of the pages comprises a plurality of memory cells sharing a wordline. Memory cells corresponding to one or more pages are connected to a single wordline. Each of the memory cells can store one or more bits of data.

Main storage 1300 or 2300 performs erase operations in memory block units. Main storage 1300 or 2300 performs read and program operations in page units. In some embodiments, read and program operations are performed in units of a plurality of pages, or in units of sub-pages smaller than a page. The unit of read and program operations of main storage 1300 or 2300 differs from the unit of erase operations thereof. Flash memories in main storage 1300 or 2300 cannot be overwritten, unlike other semiconductor memories. Consequently, an erase operation must be performed before a program operation of a flash memory in main storage 1300 or 2300.

Because many existing file systems are designed according to the characteristics of over-writable storage devices such as hard disk drives, these file systems may not be directly compatible with flash memories in which over-writing is not possible. In addition, because flash memories perform program and erase operations in different sized units, an address provided by the file system may be mismatched with an address of the flash memory in which data has been written. Accordingly, to address these characteristics, a flash translation layer (FTL) is used between the file system and the flash memories to hide erase operations of the flash memories and to convert between logical addresses provided by the file system and physical addresses used by the flash memories. The FTL is typically stored in a predetermined area of main storage 1300 or 2300 and is then loaded to storage controller 1200 or host 2100 in a power-on operation.

FIG. 6 is a diagram illustrating software layer architecture of electronic device 1000 or 2000 of FIG. 1 or 3.

Referring to FIG. 6, electronic device 1000 or 2000 comprises a software layer structure comprising an application 210, a file system 220, an FTL 230, and main storage 1300 or 2300 comprising a plurality of flash memories.

FTL 230 performs functions such as mapping between logical addresses and physical addresses, management of bad blocks, management of data protection against unexpected power interruption, and wear leveling. For example, in a program operation or a reprogram operation of main storage 1300 or 2300, FTL 230 maps a logical address generated by file system 220 into a physical address of a flash memory in main storage 1300 or 2300 that has been erased. FTL 230 uses an address mapping table for rapid address mapping. The address mapping function of FTL 230 enables host 1100 or 2100 to recognize main storage 1300 or 2300 as a hard disk drive or an SRAM and to access main storage 1300 or 2300 in the same way as the hard disk drive or SRAM.

The address mapping method of FTL 230 can perform mapping in any of various different units. For example, it can perform mapping as a page mapping method, a block mapping method, a hybrid mapping method, or others.

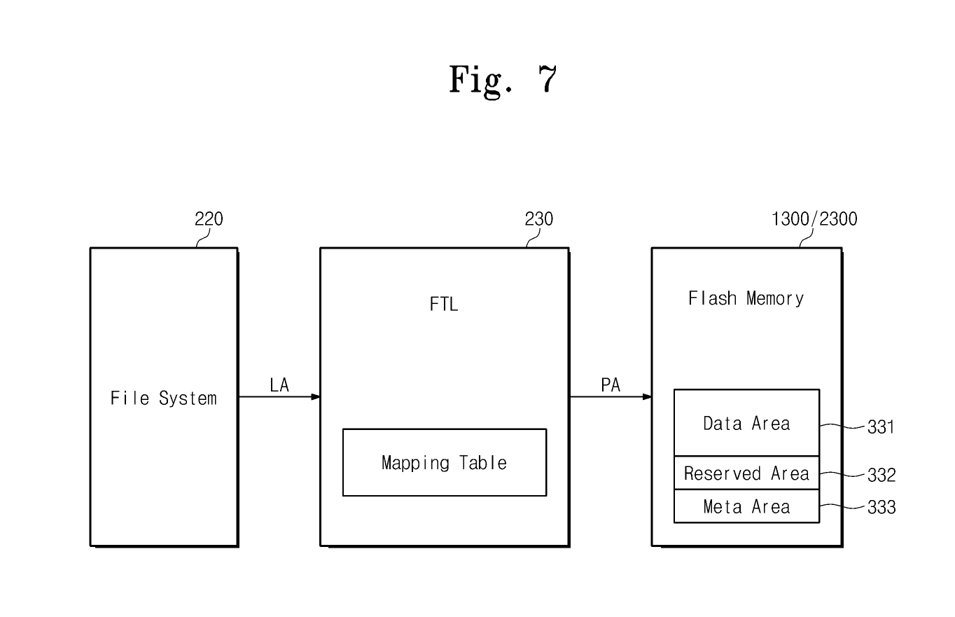

FIG. 7 is a diagram for explaining an address mapping operation performed by the software layer architecture of FIG. 6.

Referring to FIG. 7, FTL 230 receives a logical address LA from file system 220 and converts it into a physical address PA using a mapping table in a program operation. Main storage 1300 or 2300 comprises a data area 331, a reserved area 332, and a meta area 333. Data area 331 comprises a plurality of memory blocks that store user data. Reserved area 332 comprises a hidden area that is invisible to a user. FTL 230 designates a part of reserved area 332 as a free block.

In the event of a program failure, valid data in a program failed memory block is copied to the free block. The data to be stored in a program failed memory cell is reprogrammed to a corresponding memory cell of the free block. Address mapping information is stored in meta area 333 under control of FTL 230. The address mapping information is changed by the program operation, the reprogram operation, or the copy operation of the valid data.

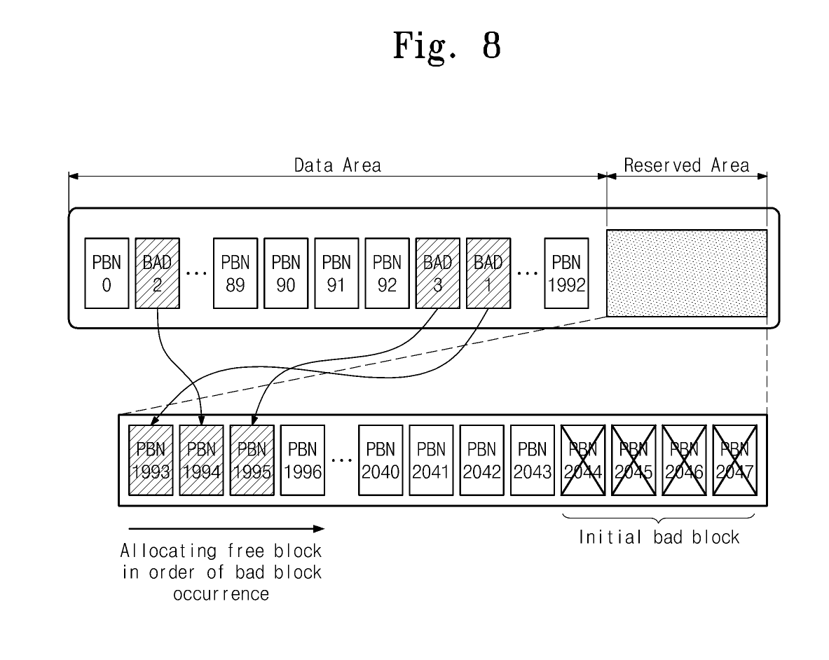

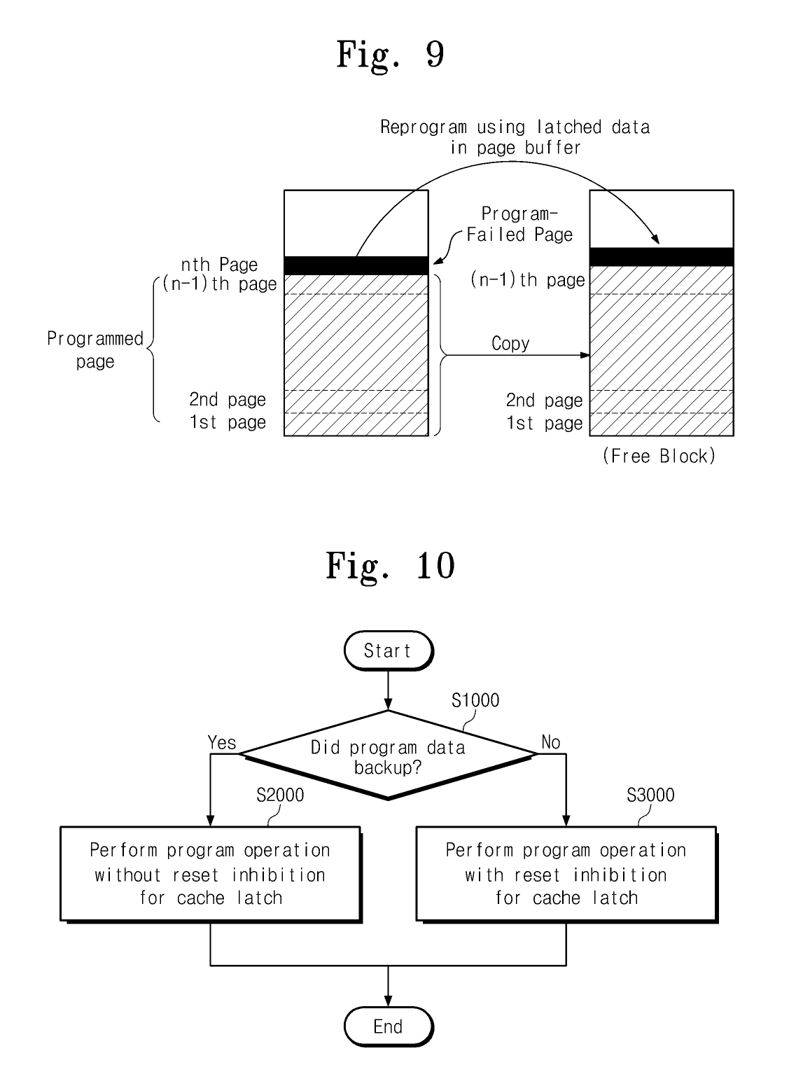

FIGS. 8 and 9 are diagrams for explaining a bad block processing method performed upon detection of a program failure.

Referring to FIGS. 8 and 9, where a program failure occurs in data area 331 of main storage 1300 or 2300, FTL 230 successively assigns free blocks PBN 1993, PBN 1994, and PBN 1995 to reserved area 332 based on the order of occurrence of program failures of bad blocks BAD1, BAD2, and BAD3. Valid data stored in bad blocks BAD1, BAD2, and BAD3 is copied to corresponding areas (e.g., corresponding pages) of newly allocated free blocks PBN 1993, PBN 1994, and PBN 1995.

The copy operation of the valid data is performed through a copyback operation. In the copyback operation, the valid data stored in bad blocks BAD1, BAD2, and BAD3 is read by page buffers and copied to the corresponding areas (e.g., corresponding pages) of the newly allocated free blocks PBN 1993, PBN 1994, and PBN 1995 without outputting the valid data to an external controller or the host. Thus, the valid data read from bad blocks BAD1, BAD2, and BAD3 is not output from main storage 1300 or 2300 in the copyback operation.

Data to be stored in the program failed memory cells of bad blocks BAD1, BAD2 and BAD3 is reprogrammed to corresponding areas (e.g., corresponding pages) of free blocks PBN 1993, PBN 1994, and PBN 1995 using the program data stored in cache latches CL of page buffer circuit 140 without re-requesting or re-providing the program data from an external source, such as a controller or host.

The program data stored in cache latches CL is used for reprogramming after being read out to the external controller or the host, and can be used for reprogramming after being stored in an internal buffer or a temporary memory block. On the other hand, the program data stored in cache latches CL can be directly reprogrammed to the corresponding areas (e.g., corresponding pages) of free blocks PBN 1993, PBN 1994, and PBN 1995 through program latches PL of page buffer circuit 140. The reprogram operation using the program data stored in cache latches CL is not limited to a specific scheme, and it may be variously implemented.

FIG. 10 is a flowchart illustrating a method of performing program failure processing in a program operation according to an embodiment of the inventive concept. In the description that follows, example method steps are indicated by parentheses.

Referring to FIG. 10, the method determines whether program data is backed up (S1000). Where the program data is backed up (S1000=Yes), the program data is programmed to corresponding memory cells without inhibiting cache latches CL of main storage 1300 or 2300 from resetting (S2000). For example, where all of the program data is stored in backup buffer 1250 of storage controller 1200 or backup buffer 2250 of host 2100, it is not necessary to inhibit cache latches CL from resetting. In this case, where a program failure occurs, the program data to be stored in program failed memory cells is reloaded from backup buffer 1250 or 2250 to page buffer circuit 140 of main storage 1300 or 2300 to perform a reprogram operation.

Otherwise, where the program data is not backed up (S1000=No), a program operation for the program data is performed with inhibiting cache latches CL from resetting (S3000). For example, where a size of backup buffer 1250 or 2250 is insufficient to store all of the program data of flash memories 1301 through 1304 or 2301 through 2304, or a current program operation is performed for the last page of data, storage controller 1200 or host 1100 or 2100 inhibits cache latches CL from resetting. In this case, the program data to be stored in the program failed memory cells is reloaded from cache latches CL to program latches PL of main storage 1300 or 2300 for reprogramming.

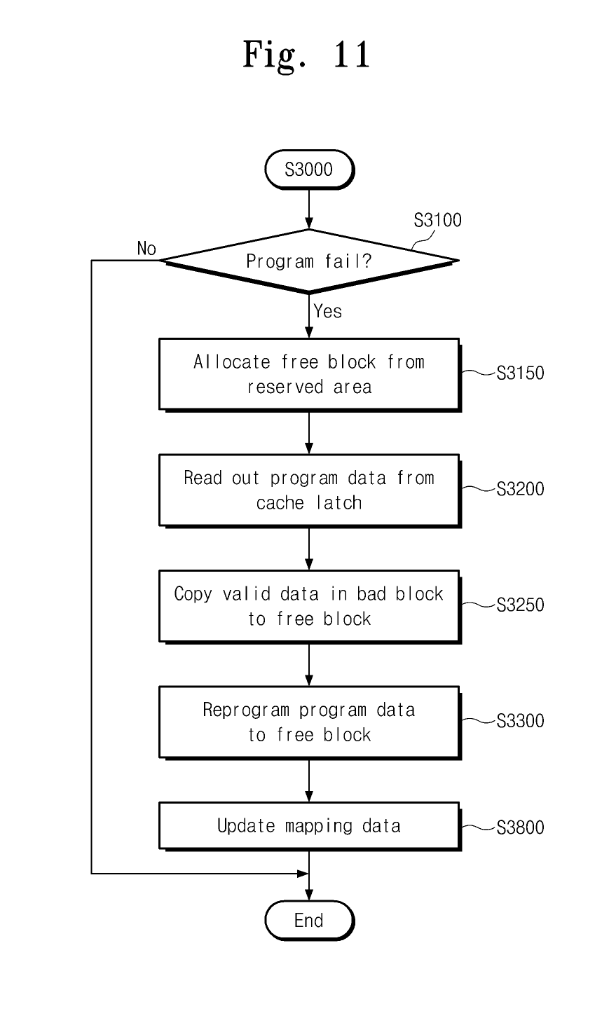

FIG. 11 is a flowchart illustrating a method of performing program failure processing in a program operation according to another embodiment of the inventive concept.

Referring to FIG. 11, the method determines whether a program failure has occurred (S3100). Where the program failure has occurred (S3100=Yes), FTL 230 assigns a free block (S3150), where the free block is a part of reserved area 332. Otherwise (S3100=No), the method is completed.

Next, the program data stored in cache latches CL is read out (S3200). The program data read out from cache latches CL is output from main storage 1300 or 2300. For instance, the program data can be output to storage controller 1200 or host 1100 or 2100.

Valid data included in the program failed memory block is copied to the free block (S3250). The program failed memory block is marked as a bad block so that additional program operations are not performed on the program failed memory block. The copy operation for the valid data is internally performed in main storage 1300 or 2300 through a copyback operation. A page structure of the program failed memory block is maintained without change. In other words, mapping information of a page address is maintained even though mapping information of a block address is changed.

Next, a reprogram operation for the program data read out from cache latches CL and transferred outside of main storage 1300 or 2300 is performed under the control of storage controller 1200 or host 1100 or 2100 (S3300). After the reprogram operation, the mapping information, which is changed by the copy operation for the valid data and the reprogram operation, is updated (S3800), and the method terminates.

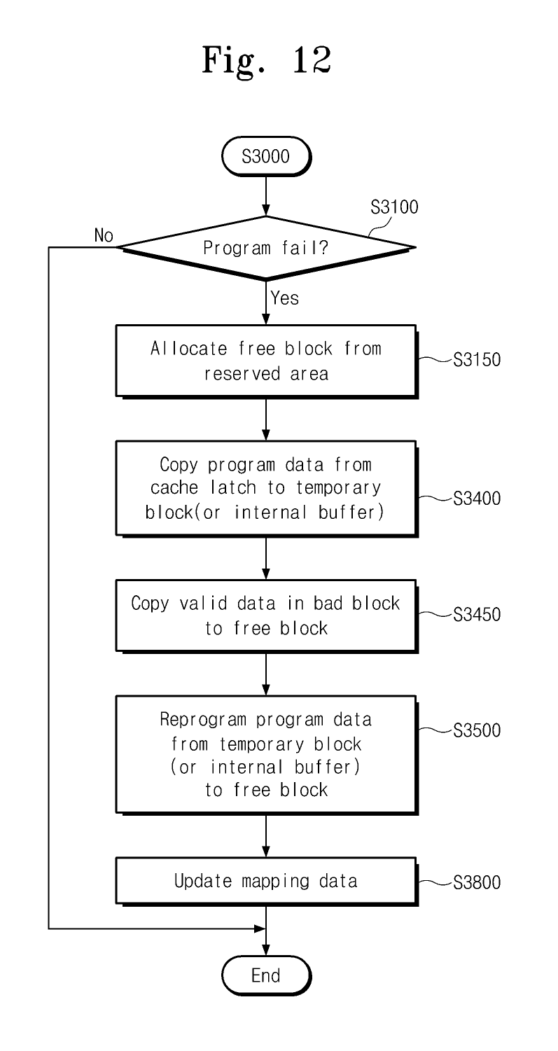

FIG. 12 is a flowchart illustrating another method of performing program failure processing according to an embodiment of the inventive concept. As indicated by common reference numerals, the method of FIG. 12 has several steps in common with the method of FIG. 11.

Referring to FIG. 12, the method first determines whether a program failure has occurred (S3100). Where a program failure has occurred (S3100=Yes), FTL 230 assigns a free block (S3150), where the free block is a part of reserved area 332. Otherwise (S3100=No), the method terminates.

Next, the program data stored in cache latches CL of main storage 1300 or 2300 is copied to a temporary block or an internal buffer within main storage 1300 or 2300 (S3400). The program data stored in cache latches CL is not output from main storage 1300 or 2300, but is stored inside main storage 1300 or 2300.

Valid data included in the program failed memory block is copied to the free block (S3450). In addition, the program failed memory block is marked as a bad block so that additional program operations are not performed on the program failed memory block. The copy operation for the valid data is internally performed in main storage 1300 or 2300 through a copyback operation, and a page structure of the program failed memory block is maintained without change. Consequently, mapping information of a page address is maintained although mapping information of a block address is changed.

Next, a reprogram operation is performed for the program data copied to the temporary block or the internal buffer in main storage 1300 or 2300 in S3400 (S3500). The reprogram operation is performed under the control of storage controller 1200 or host 1100 or 2100. After the reprogram operation, the mapping information that is changed by the copy operation for the valid data and the reprogram operation is updated (S3800), and method terminates.

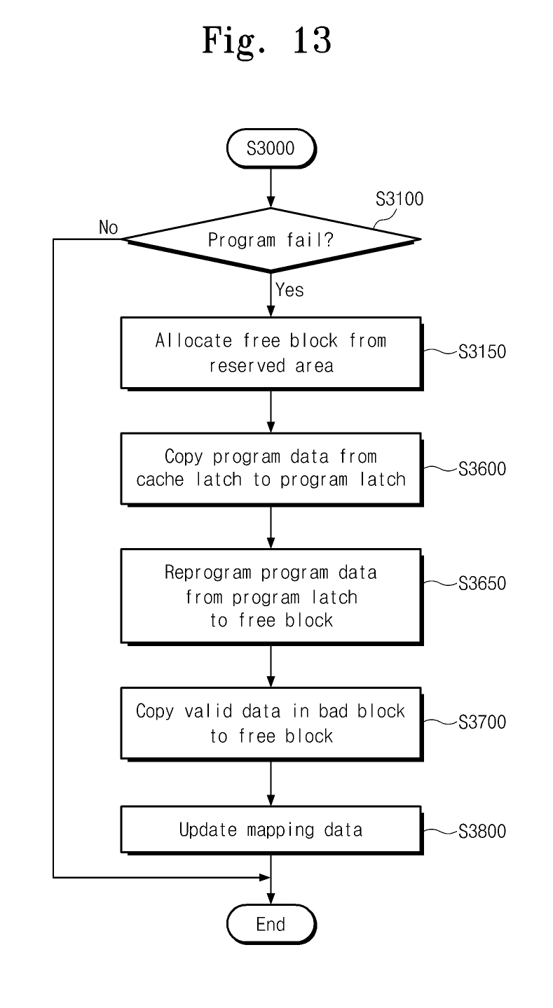

FIG. 13 is a flowchart illustrating a method of performing program failure processing in a program operation according to still another embodiment of the inventive concept. As indicated by common reference numerals, the method of FIG. 13 has several steps in common with the methods of FIGS. 11 and 12.

Referring to FIG. 13, the method begins by determining whether a program failure has occurred (S3100). Where the program failure has occurred (S3100=Yes), FTL 230 assigns a free block (S3150), where the free block is a part of reserved area 332. Otherwise (S3100=No), the method terminates.

Next, the program data stored in cache latches CL of page buffer circuit 140 in main storage 1300 or 2300 and programmed in S3000 is copied to program latches PL of main storage 1300 or 2300 (S3600). Then the program data stored in program latches PL is reprogrammed under control of storage controller 1200 or host 1100 or 2100 (S3650). In step S3650, the program data stored in cache latches CL is reprogrammed through program latch PL without outputting the program data from main storage 1300 or 2300 to storage controller 1200 or host 1100 or 2100, and without outputting the program data from page buffer circuit 140.

Valid data included in the program failed memory block is copied to the free block (S3700). In addition, the program failed memory block is marked as a bad block so that additional program operations are not performed in the program failed memory block. The copy operation for the valid data performed in S3700 is internally performed in main storage 1300 or 2300 through a copyback operation, and a page structure of the program failed memory block is maintained without change. Consequently, mapping information of a page address is maintained although mapping information of a block address is changed.

After the copy operation for the valid data, the mapping information is updated (S3800), and the method terminates.

In the methods of FIGS. 11 through 13, in response to a program failure, program data is backed up using cache latches CL in main storage 1300 or 2300, and a reprogram operation is performed using the program data backed up in cache latches CL. Accordingly, the reprogram operation can be performed even though all of the program data is not stored in a backup buffer included in host 1100 or 2100 or storage controller 1200, or the capacity of the backup buffer is not large enough to store all of the program data. As a result, program accuracy can be improved and program failure processing can be performed efficiently using a relatively low capacity backup buffer.

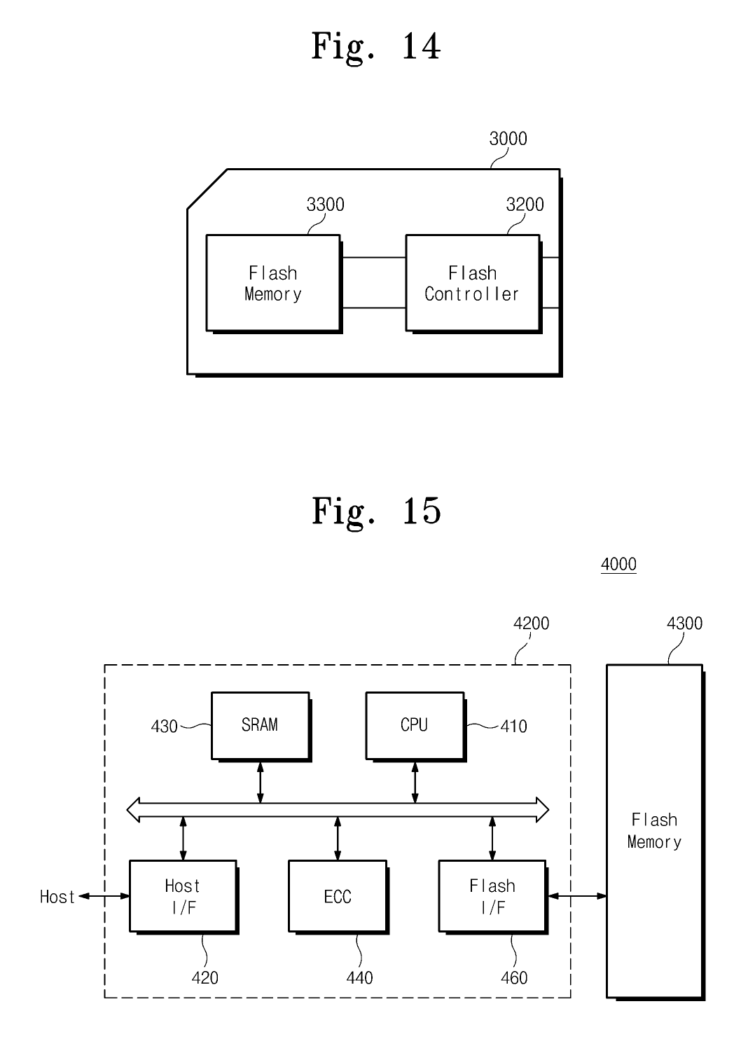

FIG. 14 is a diagram illustrating an electronic device 3000 according to another embodiment of the inventive concept.

Referring to FIG. 14, electronic device 3000 comprises a flash memory 3300 and a flash controller 3200. Electronic device 3000 can take any of various forms, such as a memory card, a semiconductor disk, a multimedia card, an SD card, a memory stick device, a hard disk drive, a hybrid drive device, or a universal flash storage card. Moreover, electronic device 3000 can be configured for compatibility with various host devices, such as a digital camera, a personal computer, and so on.

Flash memory 3300 of FIG. 14 has substantially the same configuration and functionality as main storage 1300 or 2300 of FIG. 1 or 3. For example, flash controller 3200 controls flash memory 3300 in response to the control signals from outside user device 3000. In addition, in response to a program failure, flash memory 3300 backs up program data using cache latches CL of main storage 1300 or 2300, and performs a reprogram operation using the program data backed up in cache latches CL.

FIG. 15 is a diagram illustrating an electronic device 4000 according to still another embodiment of the inventive concept.

Referring to FIG. 15, electronic device 4000 comprises a storage controller 4200 and a flash memory 4300.

Flash memory 4300 has substantially the same configuration and functionality as main storage 1300 or 2300 of FIG. 1 or 3. In some embodiments, flash memory 4300 comprises a plurality of flash memory chips or cores. Electronic device 4000 can perform methods such as those of FIGS. 11 through 13. Accordingly, in response to a program failure, flash memory 4300 can back up program data using cache latches CL of the page buffer circuit, and can perform a reprogram operation using the program data backed up in cache latches CL.

Storage controller 4200 controls flash memory 4300 and can be configured to have the same configuration as storage controller 1200 of FIG. 1 or flash controller 3200 of FIG. 14.

Electronic device 4000 can be incorporated in various types of devices, such as a personal computer, a portable computer, an ultra mobile personal computer, a workstation, a net-book, a PDA, a portable computer, a web tablet, a wireless phone, a mobile phone, a smart phone, a digital camera, a digital audio recorder, a digital audio player, a digital picture recorder, a digital picture player, a digital video recorder, a digital video player, a device capable of transmitting and receiving in a wireless environment, or any of various electronic devices in home network. Electronic device 4000 can also be incorporated in various electronic devices within a computer network or a telematics network. In addition, electronic device 4000 can also be incorporated in devices for processing radio frequency identification devices information. A combination of flash memory 4300 and storage controller 4200 can be provided as a memory card or an SSD, with storage controller 4200 operating as a memory controller.

An SRAM 430 is used as a working memory of a central processing unit (CPU) 410. A host interface 420 implements a data exchange protocol for a host connected to electronic device 4000. An error correction circuit 440 in storage controller 4200 detects and/or corrects errors in data read from flash memory 4300. A memory interface 460 interfaces with flash memory 4300. CPU 410 performs overall control operations for data exchange of storage controller 4200. Although not illustrated in FIG. 15, electronic device 4000 can further comprise a read-only memory (ROM) that stores code data for interfacing with the host.

In some embodiments, flash memory 4300 is incorporated in a multi-chip package comprising a plurality of flash memory chips. In some embodiments, electronic device 4000 is provided as a high-reliability storage medium with a low error probability, such as an SSD. Moreover, in some embodiments, storage controller 4200 is configured to communicate with an external device, such as a host, through one of various interface protocols such as USB, MMC, PCI-E, SAS, SATA, PATA, SCSI, ESDI, and IDE.

In addition, other devices and components described above can be packaged in a variety of different types of packages. For example, electronic devices 1000 through 3000, electronic device 4000, and flash memory 4300 and/or storage controller 4200 can be mounted in packages of types such as package on package (PoP), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSOP), thin small outline package (TSOP), system in package (SIP), multi chip package (MCP), wafer-level fabricated package (WFP), and wafer-level processed stack package (WSP).

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of operating a storage device comprising a flash memory, comprising:
performing a program operation to store program data in a selected memory block of the flash memory;
allocating a reserved area of the flash memory as a free block upon detecting that a program failure has occurred in the program operation;
reading the program data from a cache latch in a page buffer of the flash memory;
copying valid data stored in the selected memory block to a first area of the free block; and
reprogramming the program data read from the cache latch to a second area of the free block.

2. The method of claim 1, further comprising, before the program operation, inhibiting the cache latch from resetting.

3. The method of claim 1, wherein reading the program data from the cache latch comprises transferring the program data read from the cache latch to an external data storing area outside the flash memory.

4. The method of claim 1, wherein reading the program data from the cache latch comprises transferring the program data read from the cache latch to an internal data storing area inside the flash memory.

5. The method of claim 4, wherein the internal data storing area is formed of a temporary memory block or a buffer of the flash memory.

6. The method of claim 1, wherein reading the program data from the cache latch comprises transferring the program data read from the cache latch to a program latch of the page buffer.

7. The method of claim 1, wherein the valid data is copied to the first area of the free block through a copyback operation.

8. A method of operating a storage device comprising a flash memory, the method comprising:
inhibiting a cache latch in a page buffer of the flash memory from resetting;
loading program data stored in the cache latch to a program latch of the page buffer;
performing a program operation to store the program data loaded in the program latch to a memory block of the flash memory;
allocating a reserved area of the flash memory as a free block as a consequence of a program failure in the program operation;
reading and buffering the program data from the cache latch;
copying valid data stored in a program failed memory block to a first area of the free block; and
reprogramming the buffered program data to a second area of the free block.

9. The method of claim 8, wherein the cache latch is inhibited from resetting where the program data is a last page of data to be programmed in the program operation.

10. The method of claim 8, wherein the program data read from the cache latch is buffered in an external data storing area outside the flash memory.

11. The method of claim 8, wherein the program data read from the cache latch is buffered in an internal data storing area inside the flash memory.

12. The method of claim 11, wherein the internal data storing area is formed of a temporary memory block or a buffer of the flash memory.

13. The method of claim 8, wherein the valid data is copied to the first area of the free block through a copyback operation.

14. An electronic device, comprising:
a flash memory comprising a page buffer that retains program data in a cache latch during a program operation comprising a plurality of program loops; and
a host that controls the program operation and, in response to a program failure in the program operation, allocates a free memory block in the flash memory and controls a reprogram operation that programs the program data retained in the cache latch to the free block.

15. The electronic device of claim 14, wherein the program operation is performed on a first memory block of the flash memory, and the first memory block is designated as a program failed memory block in response to the program failure.

16. The electronic device of claim 15, wherein the free block is located in a reserved area of the flash memory, and the host controls the flash memory to copy valid data stored in the program failed memory block to a first area of the free block.

17. The electronic device of claim 16, wherein the program data retained in the cache latch is programmed to a second area of the free block.

18. The electronic device of claim 15, wherein the flash memory controls the page buffer to prevent the cache latch from resetting during the program operation.

19. The electronic device of claim 14, wherein the program data comprises multiple pages of data, and the flash memory controls the page buffer to prevent the cache latch from resetting during a most recent programming of one of the multiple pages of data.

20. The electronic device of claim 14, wherein the flash memory is incorporated in a solid state drive.
